(19) United States
(12) Patent Application Publication
(10) Pub. No.: US 2009/0310674 A1
(43) Pub. Date: Dec. 17, 2009

(54) METHOD AND DEVICE FOR CODING A SEQUENCE OF IMAGES

(75) Inventors: Fabrice Le Leannec, Mouaze (FR); Patrice Onno, Rennes (FR); Xavier Henocq, Melesse (FR)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/484,734

(22) Filed: Jun. 15, 2009

(30) Foreign Application Priority Data
Jun. 17, 2008 (FR) 0854000

(51) Int. Cl. H04N 7/32

(52) U.S. Cl. 375/240.12; 375/240.16; 375/E07.125

(57) ABSTRACT

The method of coding a sequence of images comprising at least one group of a plurality of original images, in several scalability layers, comprises, to code said group of original images, a step of coding at least one base layer on the basis of the group of original images to code to constitute an intermediate data stream.

The method also includes a step of storing the intermediate stream in a storage space of a mass memory.

Iteratively, the method performs, for each other scalability layer to be coded:
a step of obtaining prediction data for the layer to code in said intermediate data stream,
a step of coding the layer to code using said prediction data and the group of original images and
a step of adding, in the storage space, the coded layer to the intermediate stream.

The present invention concerns a method and a device for coding a sequence of images. It applies, in particular, to video coding, and especially to coding in accordance with the SVC video compression standard (SVC being an acronym for Scalable Video Coding).

The SVC video compression standard introduces functionalities of adaptability, also termed scalability, above the H264/AVC standard (AVC being an acronym for Advanced Video Coding). A video sequence may be coded by introducing different spatial, temporal and quality levels in the same bitstream.

The SVC software of reference, called JSVM (acronym for Joint Scalable Video Model) includes in particular an SVC coder. This coder is specified in such a way that a high quantity of memory is allocated to the coding of an SVC stream with several scalability levels. The memory consumption of the JSVM coder is such that it is impossible to code an SVC stream with at least two “4CIF” spatial resolution layers (of resolution 704×576) and groups of pictures 32 images long on a current personal computer having two Giga-bytes of random access memory. This high memory consumption is due to the numerous buffer memories for images, allocated by the coder before starting to code images. More particularly, the coder of reference has been designed so as to conjointly code all the scalability layers of the stream. For this, an object called “LayerEncoder” is instantiated for each spatial scalability layer and each quality layer. Each object of LayerEncoder type is dedicated to the coding of a scalability layer and works on a group of pictures basis. In practice, for each layer, this leads to the allocation of at least 407 image buffers of which the size correspond to the spatial resolution of the layer considered. For a layer of 4CIF resolution, this implies an allocation of 660 Mega-bytes per layer. Consequently, when it is attempted to code two layers of 4CIF resolution in the same SVC stream, more than 1.3 Giga-bytes are allocated at the start of the video compression program, which blocks the coding process.

This excessive memory consumption is inherent to JSVM, but exists more generally for any SVC video coder attempting to simultaneously code all the scalability layers of an SVC stream, by working on groups of pictures.

The document US 2007/0230914 is known which proposes a method for coding a scalable video stream comprising an MPEG-2 compatible base layer and a refinement layer above the base layer. The coding of the refinement layer includes a step of classifying blocks of the base layer on the basis of their texture.

The document US 2001/0024470 is also known, which discloses a method of coding a scalable video stream comprising a base layer (coded with temporal prediction techniques) and a refinement layer with fine granularity.

In each of these documents, the inter-layer prediction is carried out via decoding and complete reconstruction of the base layer then spatial upsampling (for the spatial scalability) applied to the images of the base layer. These methods thus involve fully decoded and reconstructed images and thus a considerable memory consumption.

The present invention aims to mitigate these drawbacks.

To that end, according to a first aspect, the present invention concerns a method of coding a sequence of images comprising at least one group of a plurality of original images, in several scalability layers, that comprises, to code said group of original images, a step of coding at least one base layer on the basis of the group of original images to code to constitute an intermediate data stream, a step of storing the intermediate stream in a storage space of a mass memory and, iteratively, for each other scalability layer to be coded:
a step of obtaining prediction data for the layer to code, coming from at least one already coded layer,
a step of coding the layer to code using said prediction data and the group of original images and
a step of adding, in the storage space, the coded layer to the intermediate stream.

Thus, the intermediate stream is enhanced by a scalability layer at each iteration of the elementary step of coding a scalability layer. This elementary step of coding a scalability layer is thus successively invoked until the intermediate stream contains all the scalability layers to code and becomes the final data stream.

For example, in the case of the use of the “LayerEncoder” object, since only one scalability layer is coded at a time and the intermediate result is stored in a mass memory, only one object of LayerEncoder type is instantiated at a time. The architectural modification of the JSVM thus provided therefore reduces the consumption of random access memory necessary for the execution of the coding compared with the coders of the prior art. The present invention thus provides a new architecture for a coder processing a sequence of images, layer by layer, by saving, between the successive coding of two layers, an intermediate data stream, until all the scalability layers have been coded.

In the case of the use of the “LayerEncoder” object, among the advantages of the present invention are that:
the memory consumption is limited in comparison to the JSVM coder and
an SVC stream may be coded with several scalability layers of spatial resolution higher than or equal to 704×576, with a GOP (Group Of Pictures) size greater than or equal to 32 images while using less than two Giga-bytes of random access memory.

According to particular features, the step of obtaining prediction data comprises a step of selecting an already coded layer represented by the intermediate stream, the prediction data being obtained from said selected layer. Thus, the selected layer constitutes a reference layer for the layer to code.

According to particular features, the step of obtaining prediction data comprises a step of partial decoding of the intermediate data stream without motion compensation. The prediction data supplied by this partial decoding consist, for example, of reconstructed INTRA macroblocks, coding modes for macroblocks, partitions of macroblocks, motion vectors, temporal residues, as well as indices of reference image for the temporal prediction.

According to particular features, the method of the present invention, as succinctly set forth above further comprises, for at least one scalability layer, a step of storing non-coded prediction data in the storage space of a mass memory and, for at least one other scalability layer, during the step of obtaining prediction data, said prediction data are read. Thus, it is avoided to decode the prediction data and the speed of coding the sequence of images is thus increased.

According to the features of the last two paragraphs above, the data for predictions are stored in the storage space of a mass memory. The advantage is that on coding the scalability layer on the basis of the prediction data, only the prediction data concerning the image in course of coding are read from the storage space of the mass memory. The consumption of random access memory linked to the allocation of these prediction data is thus limited.

According to particular features, during the step of coding the scalability layer on the basis of the prediction data obtained and of the group of original images, a motion compensated temporal prediction loop is performed on each group of original images to code, then estimated motion vectors and temporal and spatial residues are coded.

According to particular features, during the step of coding the scalability layer on the basis of the prediction data obtained and of the group of original images, the estimated motion vectors and the temporal and spatial residues are coded as refinement data, using an inter-layer prediction based on the prediction data obtained during the obtaining step.

According to particular features, the method of the present invention performs the coding of the same scalability layer for each group of images of the sequence of images before the coding of another scalability layer.

According to a second aspect, the present invention concerns a device for coding a sequence of images comprising at least one group of a plurality of original images, in several scalability layers, that comprises a means for coding at least one base layer on the basis of a group of original images to code adapted to constitute an intermediate data stream, a means for storing the intermediate stream in a storage space of a mass memory and processing means adapted, for each other scalability layer to be coded and for said group of original images, to iteratively:
obtain prediction data for the layer to code, coming from at least one already coded layer,
code the layer to code using said prediction data and said group of original images and
add, in the storage space, the coded layer to the intermediate stream

According to a third aspect, the present invention concerns a computer program loadable into a computer system, said program containing instructions enabling the implementation of a method of the present invention as succinctly set forth above.

According to a fourth aspect, the present invention concerns an information carrier readable by a computer or a microprocessor, removable or not, storing instructions of a computer program, that enables the implementation of a method of the present invention as succinctly set forth above.

As the particular advantages, objects and features of this device, of this program and of this information carrier are similar to those of the method of the present invention, as succinctly set forth above, they are not reviewed here.

Other particular advantages, objects and features of the present invention will emerge from the following description, given, with an explanatory purpose that is in no way limiting, with reference to the accompanying drawings, in which:

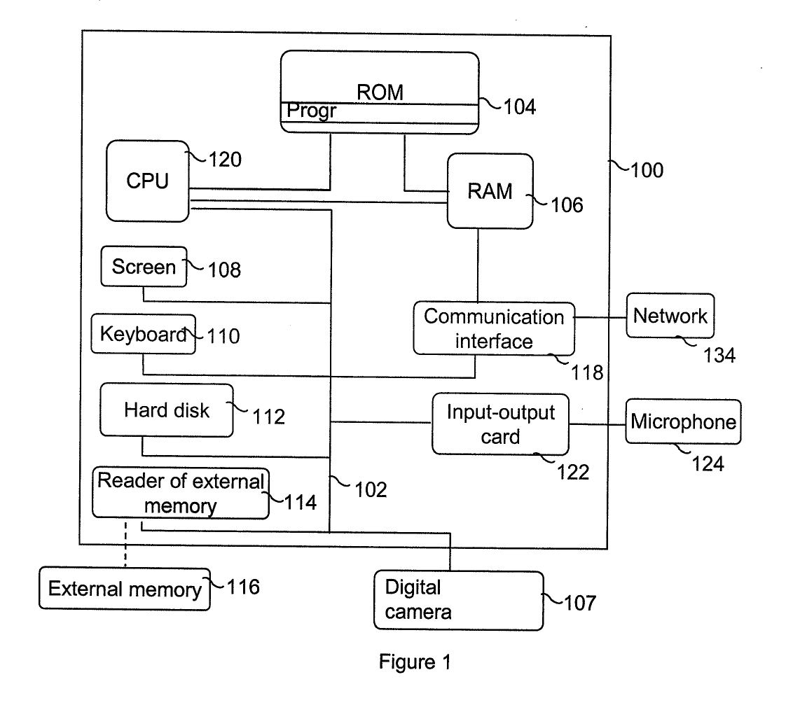

FIG. 1 is a diagram of a particular embodiment of the device of the present invention,

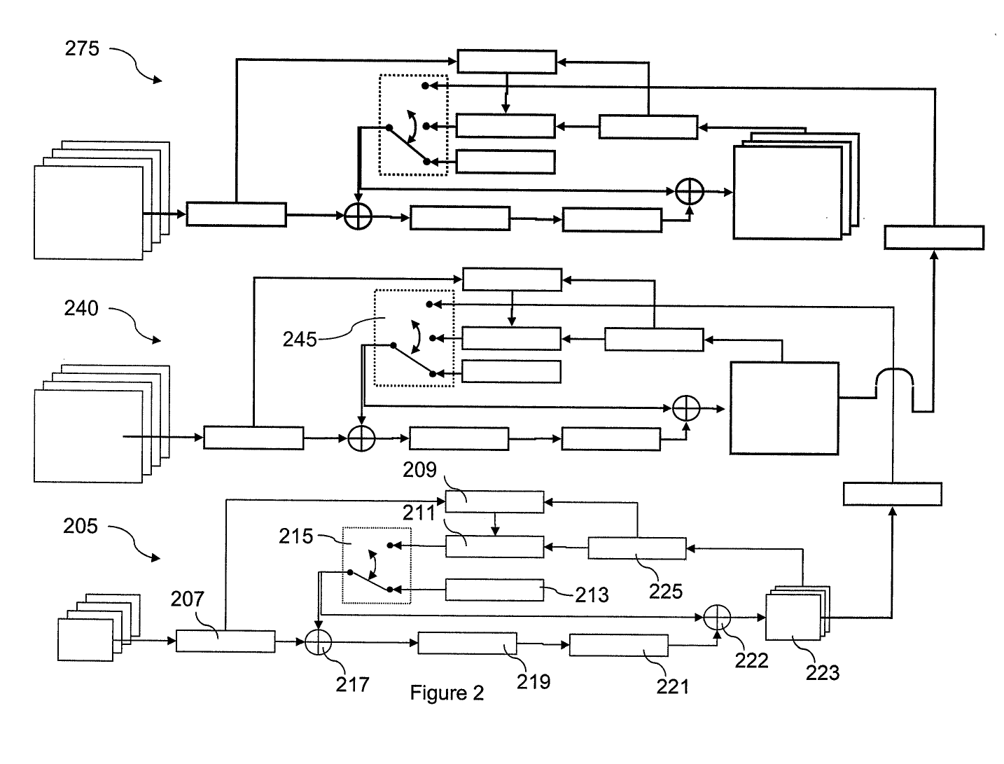

FIG. 2 represents, in the form of a block diagram, an SVC video coder known in the prior art,

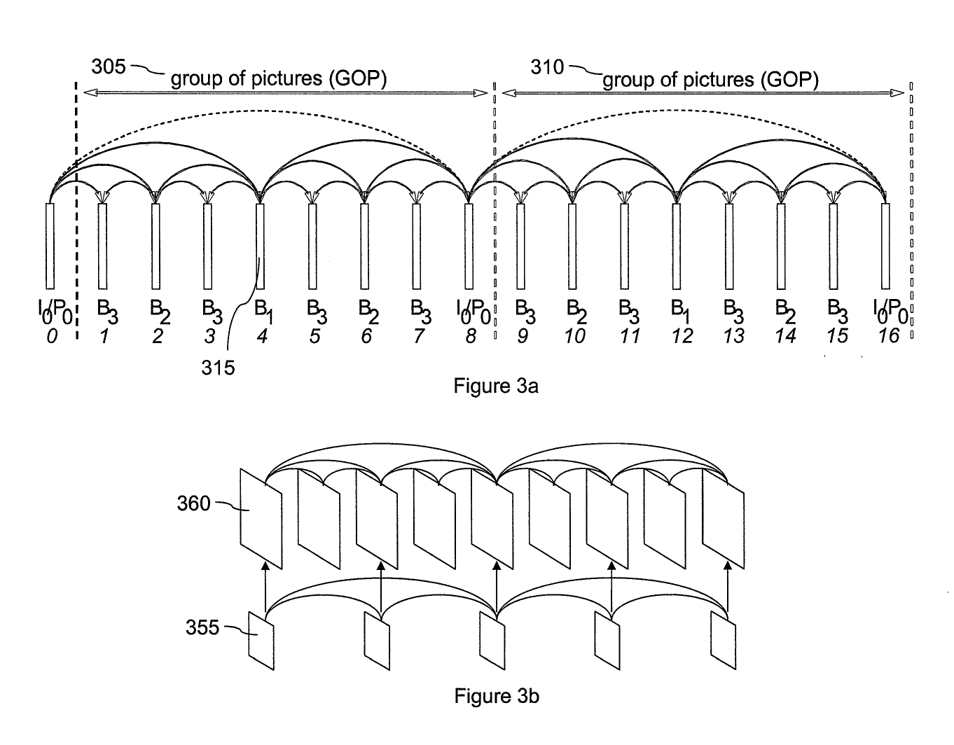

FIGS. 3a and 3b illustrate sequences of SVC images and relationships between their images,

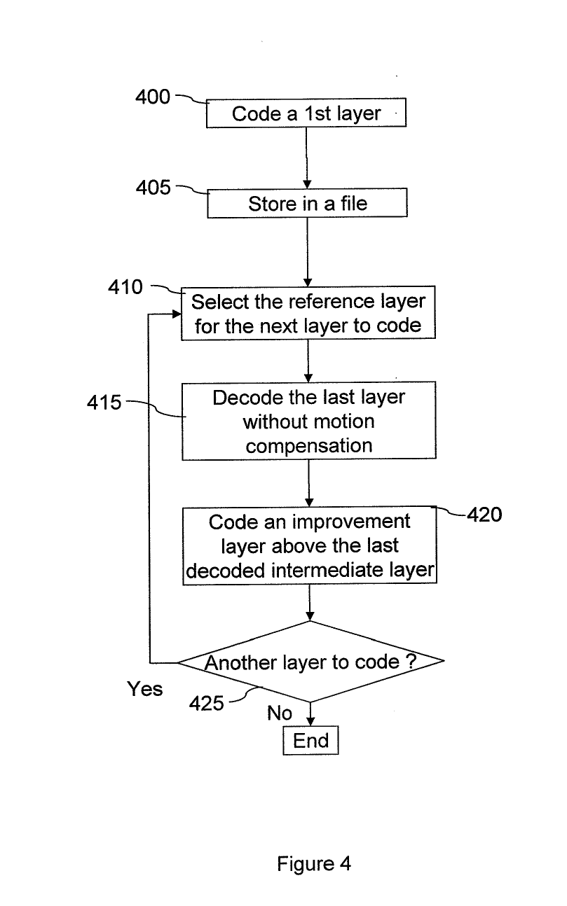

FIG. 4 illustrates, in the form of a logigram, steps implemented in a particular embodiment of the coding method of the present invention and

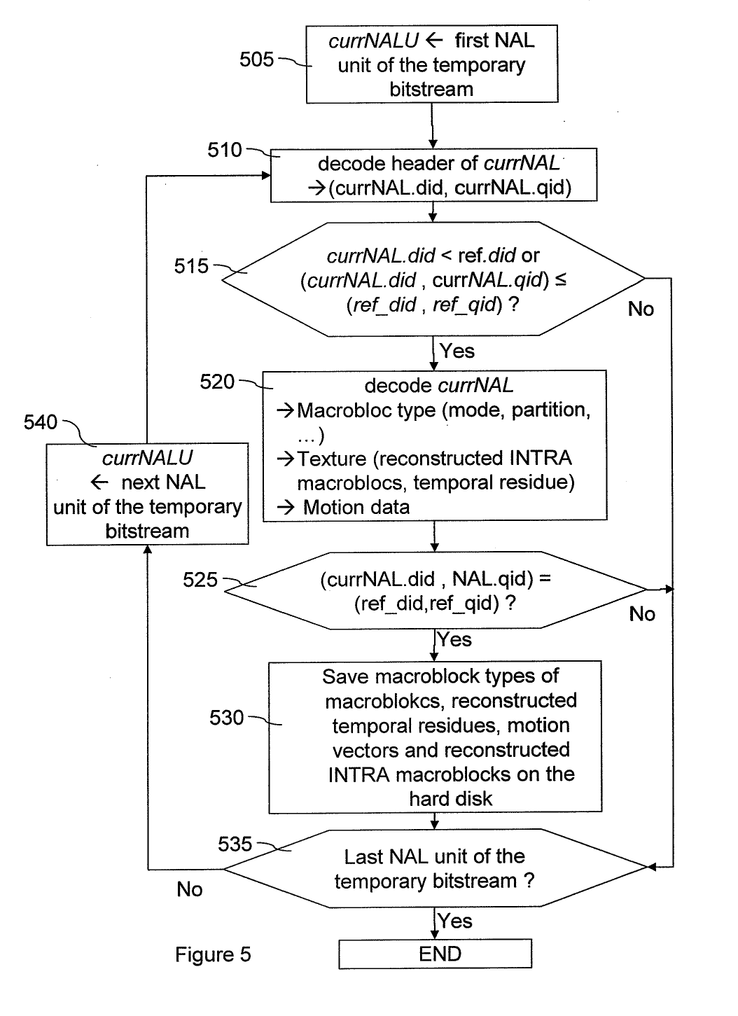

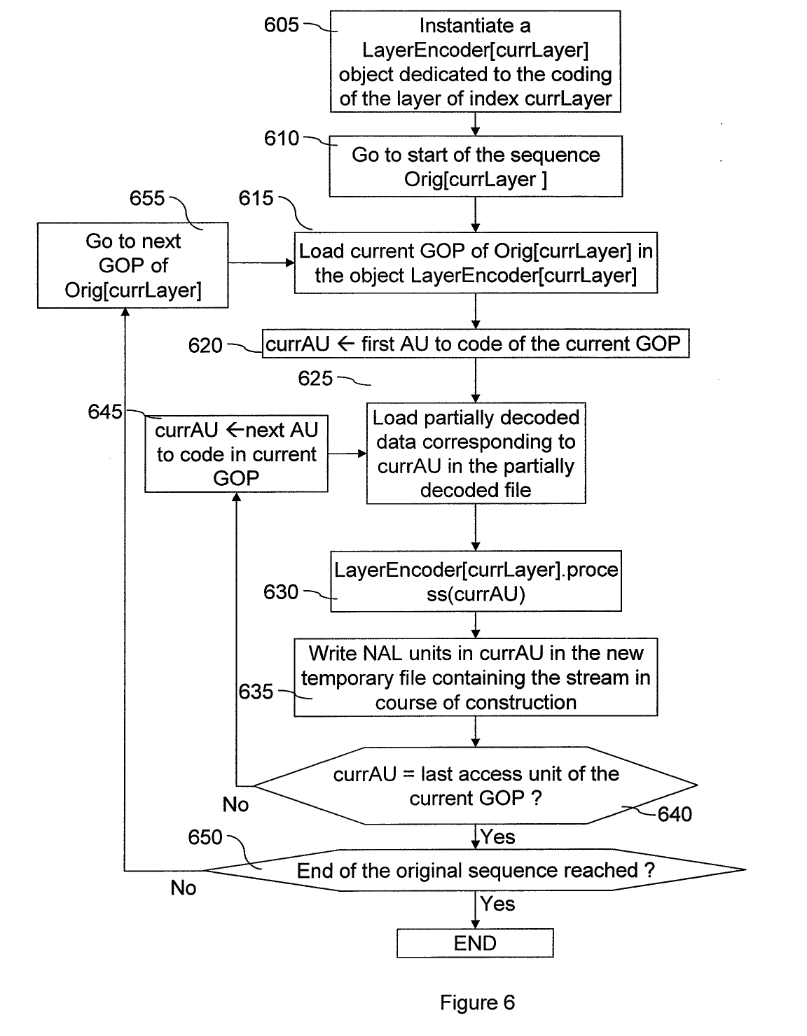

FIGS. 5 and 6 illustrate, in logigram form, steps implemented in steps illustrated in FIG. 4.

In the whole of the description, the terms “adaptability” and “scalability” have the same meaning, and the terms “bitstream” and “data stream” have the same meaning.

It can be seen in FIG. 1 that, in a particular embodiment, the device of the present invention takes the form of a micro-computer 100 provided with a software application implementing the method of the present invention and different peripherals. The device is constituted here by a server adapted to transmit coded images to clients (not shown).

The micro-computer 100 is connected to different peripherals, for example a means for image acquisition or storage 107, for example a digital camera or a scanner, connected to a graphics card (not shown) and providing image information to code and transmit. The micro-computer 100 comprises a communication interface 118 connected to a network 134 able to receive digital data to be coded and to transmit data coded by the micro-computer. The micro-computer 100 also comprises a storage means of mass memory type 112, such as a hard disk. The micro-computer 100 also comprises an external memory reader 114. An external mass memory, or “stick” comprising a memory 116 (for example a stick referred to as “USB” in reference to its communication port), as the storage means 112, may contain data to process. The external memory 116 may also contain instructions of a software application implementing the method of the present invention, which instructions are, once read by the micro-computer 100, stored in the mass storage means 112. According to a variant, the program enabling the device to implement the present invention is stored in read only memory 104 (denoted “ROM” in FIG. 1), which is also a mass memory. In a second variant, the program is received via the communication network 134 and is stored in the storage means 112. The micro-computer 100 is connected to a microphone 124 via the input/output card 122. The micro-computer 100 has a screen 108 making it possible to view the data to code or serving as interface with the user, with the help of a keyboard 110 or any other means (a mouse for example).

Of course, the external mass memory 116 may be replaced by any information carrier such as CD-ROM (acronym for compact disc-read only memory) or a memory card. More generally, an information storage means, which can be read by a computer or by a microprocessor, integrated or not into the device, and which may possibly be removable, stores a program implementing the method of the present invention.

A central processing unit 120 (designated CPU in FIG. 1) executes the instructions of the software implementing the method of the present invention. On powering up, the programs enabling implementation of the method of the present invention which are stored in a non-volatile memory, for example the ROM 104, are transferred into the random-access memory RAM 106, which then contains the instructions of that software as well as registers for storing the variables necessary for implementing the invention.

A communication bus 102 affords communication between the different elements of the microcomputer 100 or connected to it. The representation of the bus 102 is non-limiting. In particular, the central processing unit 120 is capable of communicating instructions to any element of the device directly or via another element of the device.

FIG. 2 provides a block diagram arrangement for an SVC video coder generating three scalability layers. This arrangement is organized into three stages 205, 240 and 275, respectively dedicated to the coding of each of the scalability layers generated. As input, each stage takes the original sequence to code, which may be downsampled to the spatial resolution of the scalability layer coded by the stage considered, as is the case for the first stage 205 coding the base layer. Within each stage there is implemented a motion compensated temporal prediction loop.

The first stage 205 corresponds to the temporal and spatial prediction arrangement for an H.264/AVC non-scalable video coder and is known to the person skilled in the art. It successively performs the following steps for coding the H.264/AVC compatible base layer. A current image to code, received as coder input, is divided up into macroblocks of 16×16 pixels size by the module 207. Each macroblock first of all undergoes a step of motion estimation, by the module 209 which attempts to find, among the reference images stored in a buffer memory, reference blocks enabling the current macroblock to be predicted as well as possible. This motion estimation step provides one or two indices of reference images containing the reference blocks found, as well as the corresponding motion vectors. A motion compensation module 211 applies the estimated motion vectors to the reference blocks found and copies the blocks so obtained into a temporal prediction image. Moreover, an “intra” prediction module 213 determines the spatial prediction mode of the current macroblock which would give the best performance for the coding of the current macroblock in INTRA. Next, a module 215 for mode choosing determines the coding mode, from among the temporal and spatial predictions, which provides the best rate-distortion compromise in the coding of the current macroblock. The difference between the current macroblock and the prediction macroblock so selected is calculated by the module 217, supplying a residue (temporal or spatial) to code. This residual macroblock is then subjected to the transformation (DCT acronym for “Discrete Cosine Transform”) and quantization modules 219. A module for entropy encoding of the samples so quantized is then implemented and provides the coded texture data of the current macroblock. Lastly, the current macroblock is reconstructed via a module 221 for inverse quantization, an inverse transformation and an addition 222 of the residue after inverse transformation and of the macroblock for prediction of the current macroblock. Once the current image has been thus reconstructed, it is stored in a buffer memory 223 in order to serve, through the intermediary of a suitable deblocking module 225, as reference for the temporal prediction of following images to code.

The second stage 240 of FIG. 2 illustrates the coding of the first refinement layer of the SVC stream. This layer provides a refinement of spatial resolution relative to the base layer. The coding arrangement for this layer is also known to the person skilled in the art. As indicated in FIG. 2, it is analogous to the coding arrangement for the base layer 205, the only difference being that, for each macroblock of a current image in course of coding, a prediction mode, which is additional in comparison to the coding for the base layer, may be chosen by the functional module 245 for coding mode selection. This prediction mode is called inter-layer prediction. It consists of re-using the data coded in a layer lower than the refinement layer in course of coding, as data for prediction of the current macroblock. This lower layer is termed “reference layer” for the inter-layer prediction of the refinement layer. In case the reference layer contains an image temporally coinciding with the current image, termed “base image” for the current image, the macroblock co-located (having the same spatial position) with the current macroblock which was coded in the base layer may serve as reference for predicting the current macroblock. More specifically, it may serve for predicting the coding mode, the macroblock partition, the motion data (if present) as well as the texture data (residue in the case of a temporally predicted macroblock, reconstructed texture in the case of an INTRA coded macroblock). In the case of a spatial refinement layer, operations of upsampling the texture and motion data of the reference layer are carried out. Outside this inter-layer prediction technique used in the “SVC” extension of the H.264/AVC standard, the coding of an SVC scalability layer implements a motion compensated temporal prediction loop, similar to that used for the coding of the H.264/AVC compatible base layer.

Lastly, as indicated in FIG. 2, the coding of a third layer (second refinement layer) implements a functional arrangement 275 for coding that is identical to that of the first refinement layer.

With reference to FIG. 2, it can be understood that to code an SVC stream with several scalability layers, several coding processes corresponding to stage 240 of FIG. 2 are cascaded and they are made to operate simultaneously. Concerning the architecture of the SVC coder of reference called “JSVM” (Joint Scalable Video Model), an object called “LayerEncoder” is dedicated to the coding of a scalability layer, and it is precisely the operations described above and corresponding to a stage of FIG. 2 that it carries out. When several scalability layers are desired, several objects of LayerEncoder type are instantiated (one per layer to code) in the JSVM and each one performs the coding of the scalability layer which concerns it. All the scalability layers are thus coded at the same time in the JSVM coder.

A high memory consumption of the JSVM coder results, which arises precisely from the allocation of the multiple objects of “LayerEncoder” type, which is made when several layers have to be coded. This is because, each of the LayerEncoder objects must, among other things, allocate reference image buffers that are useful for the temporal prediction in each of the layers.

FIG. 3a illustrates the structuring into groups of pictures (termed GOP's) 305 and 310 made in the video sequence to code, within each scalability layer. A group of pictures corresponds to the images over an interval of time in a sequence of images. A group of pictures is delimited by two anchoring images of I or P type. These images have the particularity of having a temporal level index equal to 0.

Within a GOP are hierarchical “B” images 315. The hierarchical B images constitute a means for providing the temporal scalability functionality of SVC. They are denoted Bi, where i≧1, represents the temporal level of the image Bi, and follow the following rule: an image of type Bi may be temporally predicted on the basis of the I or P anchoring images surrounding it, as well as the Bj, j<i images located in the same range of I or P anchoring images. Bi images can only be predicted from the anchoring images surrounding them.

FIG. 3b illustrates an example of multi-layer organization possible with SVC. Two scalability layers are illustrated: the H.264/AVC compatible base layer 355 with a spatial refinement layer 360. In FIG. 3b, the images succeed each other, from left to right, and the vertically aligned images correspond to the same original image of the group of pictures to code.

FIG. 3b gives the dependencies in terms of temporal prediction between images of a GOP in a given scalability layer. FIG. 3b also illustrates, by ascending vertical arrows, the dependencies linking the images of different scalability layers due to the inter-layer prediction. Within each layer there are illustrated two groups of pictures, within which there are hierarchical B images.

As indicated in FIG. 3b, the inter-layer prediction, implemented on coding a spatial refinement layer, consists of predicting data of the spatial refinement layer from temporally coinciding images in the base layer. For this, in the architecture of an SVC coder, in which all the scalability layers are coded at the same time, it is necessary to keep in memory the image data relative to whole GOPs, this being the case in each scalability layer.

This is in particular the case in JSVM, the coder of reference for the SVC standard. More particularly, given the coding order for the images imposed by the organization of the group of pictures in each SVC layer, each object of “LayerEncoder” type keeps several sets (or tables) of images in memory. The length of these sets corresponds to the length of the groups of pictures used in the coding of the scalability layers. These various sets store in particular the following images:
the original images to code. They are read in the original sequence and loaded into memory by each object of “LayerEncoder” type, by group of pictures.
the images reconstructed after coding then decoding without deblocking filter for the images of the current GOP, that are useful for the prediction of higher layers,
the images of spatial temporal residues decoded after coding/decoding of the residual textures of the images of the current GOP,
the images reconstructed in the maximum layer, when the motion estimation is made relative to the reconstructed images of the highest scalability layer and
the images reconstructed after deblocking filter in the different quality levels of the maximum level when the prediction between spatial levels is made with reference to intermediate quality levels of the lower spatial level.

In addition to the tables of image buffers listed above, other image buffers are also allocated by each “LayerEncoder”.

Consequently, in the SVC layers where the size of the images is significant (for example greater than or equal to the 4CIF format), the quantity of memory allocated per “LayerEncoder” object is very great (more than 660 Mega-bytes per layer for groups of pictures in 4CIF of length 32). It then becomes impossible to code an SVC stream with at least two scalability layers of spatial resolution higher than or equal to 4CI and with lengths of GOPs of 32 images, on a personal computer provided by two Giga-bytes of random access memory.

FIG. 4 presents coding steps for a sequence of original images implementing the method of coding for a group of pictures of the present invention. These steps correspond to an SVC coder architecture coding a sequence of images, one layer after another. More precisely, a given scalability layer is coded over the full duration of the sequence of images before starting to code the next scalability layer.

First of all, the base layer of the SVC stream to generate is coded, during a step 400. This first step takes as input the sequence of original images that are re-sampled at the desired spatial resolution of the base layer denoted “Orig[O]”. This provides a first H.264/AVC compatible video stream, which is saved in a temporary file stored in a storage space of a mass memory, during a step 405.

As a variant, during the step 400, several base layers are coded. For example, coding known in the prior art is implemented until a predetermined proportion of the random access memory has been used.

It is to be noted that a consequence of this variant may be that implementation of the method of the present invention is only triggered, after a coding phase of known type, in case a certain threshold of occupancy of the random access memory available for the coding application is exceeded.

According to sub-variants, during the step 405, one or more of the base layers coded during the variant of step 400 are stored in the storage space of the mass memory. Thus, at least one base layer constitutes the intermediate stream used in the following steps.

Next, during a step 410, a scalability layer is selected from the coded temporary stream, to provide a reference layer for predicting the next scalability layer to code.

During a step 415, prediction data are obtained that are useful for predictively coding a refinement layer (spatial or quality) above the base layer coded during the step 400. According to the embodiment detailed here, this step 415 performs a partial decoding of the temporary bitstream formed earlier. This partial decoding performs the SVC decoding by omitting the motion compensation step. As a matter of fact, the standard decoding of an SVC stream comprises in particular a step of motion compensated temporal prediction, carried out in the highest scalability layer contained in the stream, so as to perform the opposite operations to the coding process illustrated in FIG. 2.

However, in the SVC decoding, to perform the inter-layer prediction, decoding that is only partial of the intermediate layers, without motion compensation, is carried out in the layers other than the highest decoded layer. This partial decoding provides in particular the coding modes for the macroblocks, the reconstructed INTRA macroblocks, the motion data, the temporal residues. These data correspond precisely to the information that is predicted in the context of the prediction between SVC scalability layers.

Step 415 thus carries out that partial decoding of the SVC bitstream, without performing the motion compensation conventionally applied to the higher layer, and saves the prediction data cited above, in a dedicated file. In an alternative embodiment, the prediction data are stored in a memory space of the random access memory RAM 106. These prediction data include in particular the following parameters:
the macroblock modes (coding modes and partitions of macroblocks),
the motion parameters (motion vectors, indices of reference images),

The reconstructed INTRA macroblocks and
the decoded temporal residues.

The algorithm of step 415 of FIG. 4 is detailed by FIG. 5. It is noted that as a variant, partial decoding is not carried out of the temporary SVC stream to obtain the prediction data, but those data are saved in a file at the time that they are determined during the step of coding the temporary stream which precedes.

The result of step 415 is thus a file containing the prediction data indicated above. During a step 420, an SVC scalability layer is coded above the layers already present in the temporary SVC bitstream in course of construction, and the new layer is added to the layers already coded in the temporary file stored in a storage space of a mass memory. The specific algorithm corresponding to this step 420 is set out with reference to FIG. 6. The result of this fourth step consists in a new temporary SVC bitstream containing an additional scalability layer relative to the previous temporary stream. During the step 420, enhancement has been made of the SVC stream in course of construction saved in a temporary file stored in a storage space of a mass memory of an additional layer.

During a step 425, it is determined whether at least one layer to code remains. If yes, the steps 410 to 425 are re-iterated. Otherwise, the enhanced SVC stream obtained contains all the initially requested layers. The algorithm of FIG. 4 then ends.

In a variant (not shown), for at least one scalability layer, a step is carried out, parallel to steps 400 and 405, of saving non-coded prediction data coming from the layer in course of coding and, for at least one other scalability layer, instead of step 415, the prediction data are obtained by reading said prediction data saved for the layer selected during the step 410. Thus, it is avoided to decode the prediction data and the speed of coding the sequence of images is thus increased.

FIG. 5 explains step 415 of partial decoding of FIG. 4. As input, the algorithm of FIG. 5 takes the intermediate SVC bitstream in course of progressive construction by the algorithm of FIG. 4 as well as the reference layer selected to perform the inter-layer prediction of the next scalability layer to code.

The algorithm goes through all the NAL units contained in the temporary SVC stream. A NAL unit constitutes the elementary unit of an H.264/AVC or SVC bitstream, and is constituted by a header and a body. The header contains parameters relative to the data contained in the body. It indicates in particular the type of data contained in the body (coded image data, coding parameters for the sequence or for one or more images, etc.), and identifies the SVC scalability layer to which the NAL unit contributes. This scalability layer is identified via the spatial level (also called “dependency id”) and the quality level, respectively coded in the fields denoted “dependency_id” and “quality_id” of the NAL unit header.

After going to the first NAL unit, as current NAL unit, during a step 505, during a step 510, the decoding of the current NAL unit header provides the values of the fields dependency_id and quality_id of the NAL unit. During a step 515, it is determined whether the NAL unit belongs to a scalability layer lower than or equal to the selected reference layer. If that is the case, during a step 520, the body of the current NAL unit is decoded without performing motion compensation. In the case of NAL units containing coded image data, this provides the modes of the coded macroblocks contained in the NAL unit, the motion data of the temporally predicted macroblocks, the decoded temporal residues for the temporally predicted macroblocks, and the reconstructed texture for the INTRA macroblocks.

Next, during a step 525, it is determined whether the current NAL unit belongs to the scalability layer which was selected as reference layer for the prediction of the next scalability layer to code. If that is the case, during a step 530, the data supplied by the decoding of the current NAL unit are saved in the output file of the algorithm of FIG. 5.

Next, during a step 535, it is determined whether NAL units remain in the temporary SVC stream in course of partial decoding. If yes, during a step 540, the following NAL unit contained in the stream is proceeded to and step 510 is returned to. In the case in which the end of the temporary stream is reached, the algorithm of FIG. 5 ends.

If the result of one of the steps 515 or 525 is negative, step 535 is proceeded to.

A file is output from the steps illustrated in FIG. 5 which contains prediction data useful for coding, via the inter-layer prediction techniques of the SVC standard, the next scalability layer to add to the temporary SVC stream in course of construction.

FIG. 6 details step 420 of coding an additional SVC refinement layer and its writing in a new enhanced temporary SVC stream. The algorithm of FIG. 6 takes the following items as input:
the index of the new scalability layer to code denoted “currLayer”,
the original sequence of images to code, denoted Orig[currLayer], in its version sampled to the spatial resolution of the current layer to code currLayer,
the file coming from step 415 of partial decoding of the temporary SVC stream to enhance,
the temporary SVC stream which it is wished to enhance with the new scalability layer currLayer.

The algorithm of FIG. 6 commences, during a step 605, with the instantiation of the object of “LayerEncoder” type adapted to code the new scalability layer, and denoted “LayerEncoder[currLayer]”. This object is thus similar to the multiple objects of “LayerEncoder” type mentioned previously with reference to FIG. 2. The difference is that here only a single object of this type is instantiated.

Next, during a step 610, the start of the original sequence of images to code, Orig[currLayer], is gone to. During the steps 615 to 655, the coding of the sequence of images is carried out, GOP by GOP, by successively coding the images contained in each GOP. During a step 615, the original images of Orig[currLayer] belonging to the current GOP are thus loaded into buffers of the object LayerEncoder[currLayer] provided for that purpose.

Next, during the steps 620 to 645, the “access units” belonging to the current GOP are gone through in coding order. An access unit, or unit for accessing an SVC stream, contains the set of all the image data corresponding to the same decoded image. For example, with reference to FIG. 3b, the first access unit of the first GOP illustrated contains data from both the base layer (first image of the base layer) and refinement data in the spatial refinement layer (first image of the high layer). On the other hand, the second access unit, in order of display, only contains data in the refinement layer. This is because, as the frame rate of the base layer is half that of the high layer, one image out of two from the high layer has no temporally coincident image in the base layer.

The coding order used consists of first of all coding the images of temporal level 0, then of coding the images in increasing order of temporal level. Within the same temporal level, the images are coded in their order of appearance in the original sequence.

For each access unit of the current GOP to code, the prediction data useful for predicting the current access unit in the scalability layer currLayer is read, during a step 625, in the file coming from the partial decoding, as set out with reference to FIG. 5. These prediction data are loaded into the buffers adapted for that purpose in the LayerEncoder[currLayer] object.

During a step 630, the coding process for the current image is invoked, that is to say the contribution from the scalability currLayer layer in course of coding to the current access unit denoted “currAU” in FIG. 6. This coding thus provides a NAL unit which contains the image data which have just been coded. This NAL unit is then written in the new SVC intermediate file in course of construction, during a step 635. For this, all the NAL units belonging to the access unit currAU and which were already present in the temporary stream as input to the algorithm are first of all copied into the SVC output from the algorithm. The NAL unit which has just been coded is then written after those NAL units copied into the temporary SVC stream in course of formation.

During a step 640, it is determined whether the last access unit of the current GOP has been processed. If yes, a step 650 is proceeded to. Otherwise, during a step 645, the next access unit to code of the current GOP is proceeded to and step 625 is returned to.

During the step 650, it is determined whether the last GOP has been processed. Of not, during a step 655, the following GOP is proceeded to and step 615 is gone back to.

Lastly, the algorithm of FIG. 6 ends when all the GOPs of the sequence Orig[currLayer] have been processed. The algorithm of FIG. 6 provides as output a new SVC stream that is enhanced relative to the temporary SVC stream supplied as input to that algorithm, this enhanced stream being stored in a storage space of a mass memory.

1. A method of coding a sequence of images comprising at least one group of a plurality of original images, in several scalability layers, that comprises, to code said group of original images, a step of coding at least one base layer on the basis of the group of original images to code to constitute an intermediate data stream, a step of storing the intermediate stream in a storage space of a mass memory and, iteratively, for each other scalability layer to be coded:
a step of obtaining prediction data for the layer to code, coming from at least one already coded layer,
a step of coding the layer to code using said prediction data and the group of original images and
a step of adding, in the storage space, the coded layer to the intermediate stream.

2. A method according to claim 1, wherein the step of obtaining prediction data comprises a step of selecting an already coded layer represented by the intermediate stream, the prediction data being obtained from said selected layer.

3. A method according to claim 2, wherein the step of obtaining prediction data comprises a step of partial decoding of the intermediate data stream without motion compensation.

4. A method according to claim 2, that further comprises, for at least one scalability layer, a step of storing non-coded prediction data in the storage space of a mass memory and, for at least one other scalability layer, during the step of obtaining prediction data, said prediction data are read.

5. A method according to claim 2, wherein, during the step of coding the scalability layer on the basis of the prediction data obtained and of the group of original images, a motion compensated temporal prediction loop is performed on the group of original images to code, then estimated motion vectors and temporal and spatial residues are coded.

6. A method according to claim 5, wherein during the step of coding the scalability layer on the basis of the prediction data obtained and of the group of original images, the estimated motion vectors and the temporal and spatial residues are coded as refinement data, using an inter-layer prediction based on the prediction data obtained during the obtaining step.

7. A method according to claim 1, wherein the step of obtaining prediction data comprises a step of partial decoding of the intermediate data stream without motion compensation.

8. A method according to claim 1, that further comprises, for at least one scalability layer, a step of storing non-coded prediction data in the storage space of a mass memory and, for at least one other scalability layer, during the step of obtaining prediction data, said prediction data are read.

9. A method according to claim 1, wherein, during the step of coding the scalability layer on the basis of the prediction data obtained and of the group of original images, a motion compensated temporal prediction loop is performed on the group of original images to code, then estimated motion vectors and temporal and spatial residues are coded.

10. A method according to claim 9, wherein during the step of coding the scalability layer on the basis of the prediction data obtained and of the group of original images, the estimated motion vectors and the temporal and spatial residues are coded as refinement data, using an inter-layer prediction based on the prediction data obtained during the obtaining step.

11. A method according to claim 1, that comprises the coding of the same scalability layer for each group of images of the sequence of images before the coding of another scalability layer.

12. A device for coding a sequence of images comprising at least one group of a plurality of original images, in several scalability layers, that comprises a means for coding at least one base layer on the basis of a group of original images to code adapted to constitute an intermediate data stream, a means for storing the intermediate stream in a storage space of a mass memory and processing means adapted, for each other scalability layer to be coded and for said group of original images, to iteratively:
obtain prediction data for the layer to code, coming from at least one already coded layer,
code the layer to code using said prediction data and said group of original images and
add, in the storage space, the coded layer to the intermediate stream.

13. A device according to claim 12, wherein the processing means are adapted to obtain prediction data based on a selected already coded layer represented by the intermediate stream.

14. A device according to claim 13, wherein the processing means are adapted to obtain prediction data based on a partial decoding of the intermediate data stream without motion compensation.

15. A device according to claim 13, that further comprises storing means for storing non-coded prediction data in the storage space of a mass memory, for at least one scalability layer, the processing means being adapted to read said prediction data for obtaining prediction data, for at least one other scalability layer.

16. A device according to claim 13, wherein the processing means are adapted, for coding the scalability layer on the basis of the prediction data obtained and of the group of original images, to perform a motion compensated temporal prediction loop on the group of original images to code, and then to code estimated motion vectors and temporal and spatial residues.

17. A device according to claim 16, wherein the processing means are adapted, for coding the scalability layer on the basis of the prediction data obtained and of the group of original images, to code the estimated motion vectors and the temporal and spatial residues as refinement data, using an inter-layer prediction based on the prediction data obtained during the obtaining step.

18. A device according to claim 12, wherein the processing means are adapted, for obtaining prediction data, to partially decoding the intermediate data stream without motion compensation.

19. A computer program that can be loaded into a computer system, said program containing instructions enabling the implementation of the method according to claim 1.

20. A removable or non-removable carrier for computer or microprocessor readable information, storing instructions of a computer program, that makes it possible to implement the method according to claim 1.
